(19) United States
(12) Patent Application Publication
(10) Pub. No.: US 2007/0289147 A1
(43) Pub. Date: Dec. 20, 2007

(54) BATTERY-0PERATED PRUNING DEVICE

(76) Inventor: Charles Dana Irwin, Westerville, OH (US)

Correspondence Address: STANDLEY LAW GROUP LLP, 495 METRO PLACE SOUTH, SUITE 210, DUBLIN, OH, 43017, US

(21) Appl. No.: 11/763,921

(22) Filed: Jun. 15, 2007

Related U.S. Application Data
(60) Provisional application No. 60/804,973, filed on Jun. 16, 2006.

(51) Int. Cl. B27B 17/00

(52) U.S. Cl. 30/381

(57) ABSTRACT

A device for cutting woody vegetation has a high-impact thermoplastic housing with a handle formed thereon for single-handed use by a left- or right-handed user. A cutting bar extends from the housing, with an endless cutting chain arranged on a track provided on a periphery of the cutting bar. Cutting elements are disposed on the endless chain. A direct current electric motor is mounted longitudinally in the housing such that a drive shaft of the motor terminates in a worm gear that transmits drive torque to a drive gear engaged with the endless chain. The cutting bar and electric motor are sized and positioned within the housing such that a balance point of the housing is located at an end of the handle portion in the direction of the cutting bar. Power for the electric motor is provided by a battery pack worn by the user.

### CROSS-REFERENCE TO RELATED APPLICATIONS

This application is a non-provisional of U.S. Ser. No. 60/804,973, filed 16 Jun. 2006, which is incorporated by reference as if fully recited herein.

### TECHNICAL FIELD

The present invention relates to a power device useful in cutting woody vegetation. In an exemplary embodiment, the device is battery-powered and may be wielded single-handedly by a user by locating the battery remotely from the device body. In most exemplary embodiments, the motive power for the device is provided by a battery pack that is worn by the user, the battery pack communicated to the device by flexible conduit.

### BACKGROUND OF THE ART

Power saws, particularly power chain saws, are well-known and very useful for cutting woody materials. Such power equipment requires a concentrated amount of energy to provide the necessary torque, so these devices are typically powered by a gasoline engine or an alternating current electric motor, either of which is bulky enough in itself to require a user to devote both hands to the effort.

Some efforts to provide a battery-powered device attempt to encase the battery pack into the same housing as the cutting portion, whether this cutting portion is a chain saw or a pair of moving blades, as in a pruner. These devices inevitably are sufficiently heavy that they require both hands of the user. One such instance is provided by U.S. Pat. No. 5,685,080 to Amano and assigned to Makita Corporation of Japan. The chain saw disclosed there is provided with grips for both hands, obviously due to the weight of the device. Since the grips are disposed for use by a right-handed user, the use of the device by a left-handed user is impeded, which can present a safety hazard.

Simply put, a cutting device that requires two-handed use may be inherently more dangerous than a device that allows single-handed use, even though the two-handed use would seemingly keep both hands of the user engaged and out of harm's way. When the user of a two-handed device gets into a situation where one hand is removed from the device, such as to move brush near the work area or to stabilize the user (on a ladder, for example), the removal of the hand from the device exacerbates the problem, as the device is not designed to be wielded in a one-handed manner.

It is therefore an unmet advantage of the prior art to provide a power pruning or cutting device for woody vegetation or the like that is battery-powered, where the power supply is adapted to be worn by the user, the power being supplied through a flexible conduit to a motor in the device. In this manner, the device is of sufficiently light weight that it requires only a single hand of the user for safe operation.

### SUMMARY OF THE INVENTION

This and other features and advantages are provided by the battery-powered pruning device for single-handed use by a user in cutting woody vegetation. Such a device has a housing that is adapted for single-handed use. A means for cutting extends operatively from an end of the housing and a means for powering the cutting means, contained within the housing, and operatively engaged with the cutting means.

The preferred embodiments of the device will have a power supply that is adapted to be worn on the body of the user with a means for flexibly communicating the power supply to the powering means. In such embodiments, the flexible communication means would preferably be an insulated power cord, with plugs at each end for connection to the housing and power supply. Preferably, the power supply would be a battery pack of rechargeable cells, in a holster for attachment to the user, preferably near the user's waist.

The device housing has a handle portion, with the powering means contained therein.

The cutting means and power means are sized and positioned within the housing such that a balance point of the housing is located at an end of the handle portion in the direction of the cutting means.

The handle portion is arranged on the housing for gripping by either a left- or right-handed user.

The powering means preferably is a direct current electric motor mounted longitudinally in the handle portion. A drive shaft of the motor would terminate in a gear, typically a worm gear.

The cutting means is typically comprised of a cutting bar, an end of which is mounted in the housing, with an endless cutting chain arranged on a track defined by a periphery of the cutting bar, and a drive gear engaged with each of endless cutting chain and the drive shaft gear of the motor.

A plurality of cutting elements is disposed on the endless cutting chain.

The housing will usually comprise a molded thermoplastic, particularly a high-impact acrylonitrile-butadiene-styrene copolymer.

### BRIEF DESCRIPTION OF THE DRAWINGS

In addition to those mentioned above, will become apparent to those skilled in the art from a reading of the following detailed description in conjunction with the accompanying drawings wherein identical reference characters refer to identical parts and in which:

FIG. 1 is a perspective view of an exemplary embodiment, the housing in place;

FIG. 2 is a perspective view similar to FIG. 1, but with housing elements removed to expose internal features;

FIG. 3 is a side elevation view from the right side of FIG. 1, with the housing shown in phantom lining to reveal the relationship of the internal elements to the housing;

FIG. 4 is an enlarged front elevation view of the FIG. 1 embodiment, with the housing shown in phantom lining; and

FIG. 5 is an enlarged rear elevation view of the FIG. 1 embodiment.

### DETAILED DESCRIPTION OF A PREFERRED EMBODIMENT

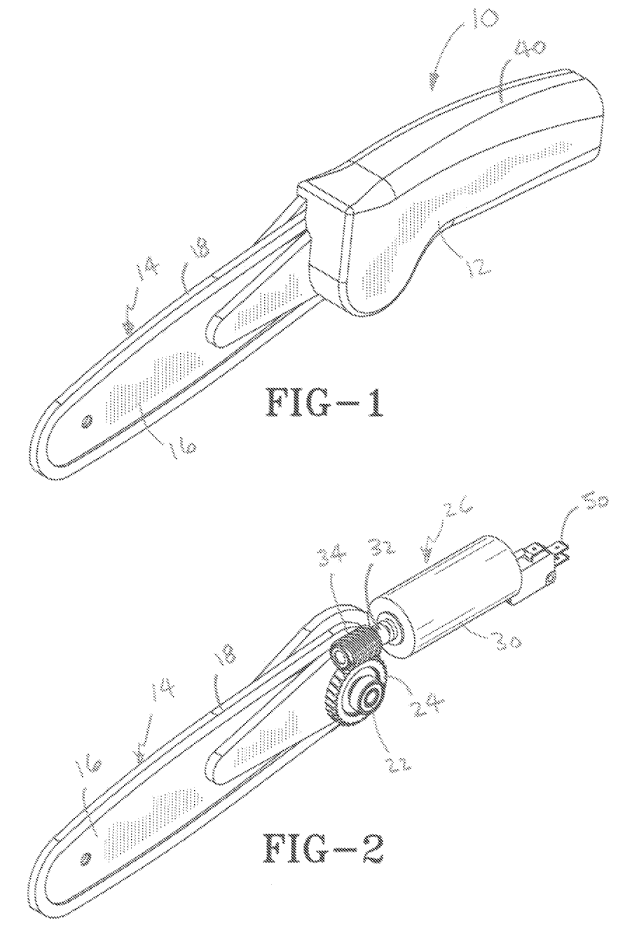

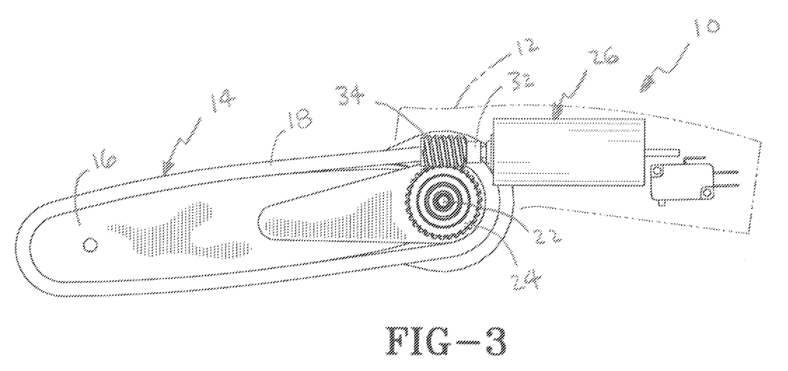

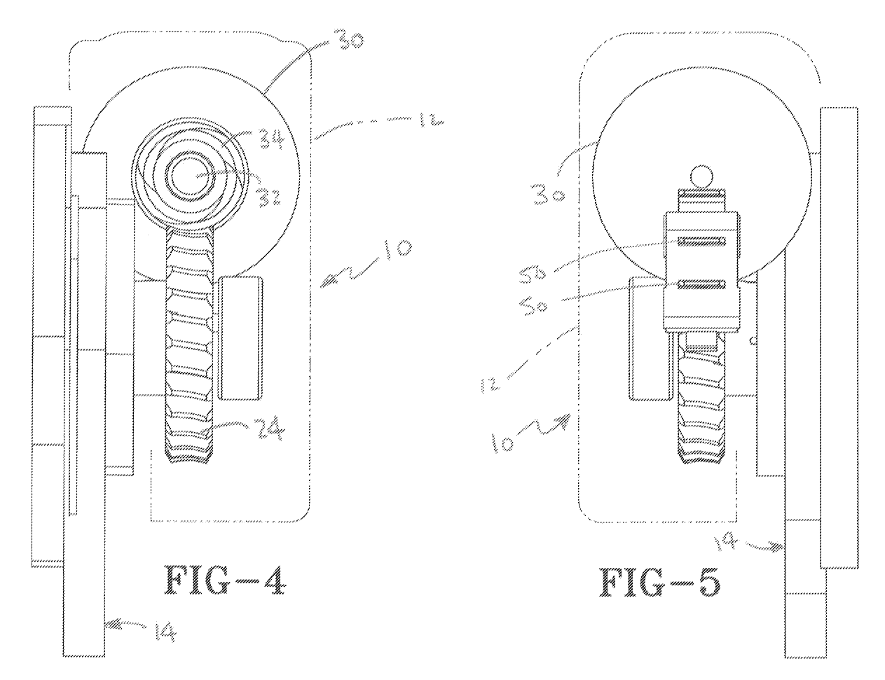

FIGS. 1 though 6 show various aspects of an exemplary embodiment of a device 10, intended for one-handed use by a person in cutting vegetation, particularly woody vegetation. A particular application of the device is for cutting palm fronds and vegetation having a similar character. The device 10 has a housing 12. The housing would preferably molded from a high-impact polymeric material. A particularly suitable material is an acrylonitrile-butadiene-styrene (“ABS”) copolymer, although high-density polyethylene and other polymers will be useful. The housing 12 is ergonomically designed, as will be explained in more detail.

Positioned at one end of the housing 12, and extending therefrom in an operative manner, is a means 14 for cutting. The exemplary cutting means 14 illustrated in the drawings is a cutting bar 16 that extends in the range of from about 6 to about 8 inches from the housing 12. The cutting bar 16 is shown with an endless loop 18 of cutting chain 18 passing around a periphery of the cutting bar. A portion of the cutting bar 16 and chain 18 closest to the housing are contained in the housing 12, and safe product design practice may well cover a significant portion of this end of these parts, to protect the user.

In many embodiments of the device, the cutting bar 16 may be enlarged slightly around the periphery to accommodate a race or track on which the cutting chain 18 is housed. Extending outwardly from the cutting chain 18 is a plurality of cutting elements, which are preferably uniformly distributed along the cutting chain 18. The particular design of the cutting elements will be known to one of ordinary skill, although specifics may vary according to the particular intended application.

A drive gear (not shown) is used to drive the cutting chain 18 around the cutting bar 16. In most applications, the drive gear will be located near the end of the cutting bar 16 that is in the housing 12. This drive gear is typically on a short shaft 22 that has a further gear 24 mounted on it, the further gear 24 receiving drive torque from a power means 26 contained in the housing.

The torque for the cutting means 14 is very preferably provided by an electric motor 30, and, more preferably, a direct current electric motor. A typical motor useful in this application will have a diameter that permits the motor to be mounted in the handle portion of the housing 12. For this reason, the diameter of the motor will preferably be less than 52 mm. Weight and diameter of the motor should each be limited as much as possible. The power requirement will typically be in the 9.6 to 30 volt range, and more preferably in the 12 to 18 volt range. The output torque of the motor 30 will preferably in the range of 35 to 75 mNm, and this may be affected by the use of known gear reduction techniques. In the illustrated embodiment, the torque generated by the motor 30 is passed to a drive shaft 32 that rotates in a plane that extends along a length of the housing 12. That plane is also preferably a plane that is parallel to a plane of the cutting bar 16. In the embodiment shown, the drive shaft 32 terminates in an arrangement for translating the torque is a worm gear 34, operatively engaged to the drive for the cutting chain 18. Usually this will be through engagement with further gear 24, but it can be a direct engagement with drive gear 22.

For several reasons, the motor 30 will be mounted within the housing 12, very close to a portion of the housing that serves as a hand grip or handle 40 for the user. By doing this, a very favorable weight distribution is obtained and the relative length of the drive shaft 32 is shortened.

Achieving the desired weight distribution will usually place a balance point of the housing toward an end of the handle portion that is in the direction of the cutting means. If the handle portion has a generally circular cross-section, the balance point is preferred to be in an area of the handle portion that corresponds to the space between the thumb and forefinger of the user. The preferred handle portion can be used equally well by a left- or a right-handed user. As the use by left-handed users of power equipment designed for use by right-handed users is a common reason for injury, this provides a distinct advantage.

Control of the motor 30 is also provided in the handle portion of the housing 12. In many instances, an “on/off” trigger, typically mounted in a trigger guard, will be used. Another feature that will be commonly found is a trigger lock, especially one that would be positioned on an upper medial portion of the handle portion to operate as a “dead man switch” by cutting power to the motor 30 when the device is not properly gripped. The specific wiring of these controls to the motor are not illustrated, as they will be well known to one of ordinary skill.

In most embodiments, the power supply will also constitute an element of the device 10. In the exemplary embodiment, the power supply will be a battery pack, preferably housed in a holster that allows attachment of the battery pack to the person of the user, preferably through a clip that may be attached either to a belt already worn by the user or to a belt provided with the device 10. In other embodiments that are not illustrated, the holster may be a part of a harness worn by the user. In the preferred embodiments, the battery pack will provide a long-life, rechargeable source of the direct current, usually in the range of about 12 to 18 volts DC, to power the motor 30. By locating the power holster remote from the device housing, the weight of the power supply is placed close to the user's torso and need not be borne by the hands and arms of the user, enhancing the single-handed use capability.

An alternate power supply could include a portable fuel cell that would be worn by the user in the same manner as the battery pack and provide a similar amount of electrical power.

With battery pack situated remote from the motor, it is necessary to communicate the battery pack with the motor. In the illustrated embodiment, this is achieved through the holster and a power cord. Internal to a preferred holster are electrical contact means that engage the battery pack when it is seated in the holster, preferably in a secure and lockable manner. In some embodiments, holster can be provided with means for recharging the battery pack in an alternating current power source. However, other embodiments will require the battery pack to be removed from the holster and placed in a separate charging system to be recharged, as this allows the weight of the holster to be minimized. Power cord will typically be a flexible, coiled electrical cord, typically from four to six feet in length, with one end connected to the device housing 12 and the other end connected to the holster. Such cords are commonly in use and an appropriate cord selection will be made once the motor and the power supply are selected. Because the power supply will always be outside of the housing 12, many embodiments may “hard-wire” the power cord to the housing 12, while providing a plug for engaging a corresponding plug at the holster, although plugs could be supplied at either or both ends. In situations where the battery pack can be recharged while engaged in the holster, there are clear advantages provided by using such a plug means at the holster to readily connect/disconnect the power cord. The power cord will typically connect to the housing 12 at an end of the housing opposite the cutting means 14, to separate the cord and cutting means as much as possible. For this reason, a male plug connection 50 is shown. In a preferred embodiment, and to the extent that such standards are established, the plug connection 50 would conform to a standard configuration for a direct current connection of the specific voltage being delivered therethrough.

While the illustrated embodiment shows an endless toothed chain or belt, other variations of the cutting means will be known and can be applied to the embodiments. One such additional means is a pair of reciprocating blades. Such a pair of blades could reciprocate longitudinally or about a pivot point.

What is claimed is:

1. A device for single-handed use by a user in cutting woody vegetation, comprising:
a housing adapted for single-handed use;
a means for cutting, extending operatively from an end of the housing; and
a means for powering the cutting means, contained within the housing, and operatively engaged with the cutting means.

2. The device of claim 1, further comprising:
a power supply, remote from the housing and adapted to be worn on the body of the user; and
a means for flexibly communicating the power supply to the powering means.

3. The device of claim 2, wherein:
the flexible communication means comprises an insulated power cord, a plug at a first end thereof adapted for connection to the housing and a plug at the second end thereof adapted for connection to the power supply.

4. The device of claim 2, wherein:
the power supply comprises a holster for attachment to a belt of the user.

5. The device of claim 2, wherein:
the power supply further comprises a battery pack of rechargeable cells.

6. The device of claim 1, wherein:
the housing comprises a handle portion, with the powering means contained therein.

7. The device of claim 6, wherein:
the cutting means and power means are sized and positioned within the housing such that a balance point of the housing is located at an end of the handle portion in the direction of the cutting means.

8. The device of claim 6, wherein:
the handle portion is arranged on the housing for gripping by either a left- or right-handed user.

9. The device of claim 1, wherein:
the powering means comprises a direct current electric motor mounted longitudinally in the handle portion, a drive shaft of the motor terminating in a worm gear.

10. The device of claim 9, wherein:
the cutting means comprises a cutting bar, an end of which is mounted in the housing, an endless cutting chain arranged on a track defined by a periphery of the cutting bar, and a drive gear engaged with each of the worm gear and the endless cutting chain.

11. The device of claim 10, wherein:
a plurality of cutting elements are disposed on the endless cutting chain.

12. The device of claim 1, wherein:
the housing comprises a molded thermoplastic.

13. The device of claim 12, wherein:
the thermoplastic is a high-impact acrylonitrile-butadiene-styrene copolymer.

14. A device for cutting woody vegetation, comprising:
a high-impact thermoplastic housing comprising a handle portion adapted for single-handed use by a left or right-handed user;
a cutting bar, a first end extending from an end of the housing and a second end thereof mounted in the housing, with an endless cutting chain arranged on a track defined by a periphery of the cutting bar, the endless cutting chain having a plurality of cutting elements disposed thereupon, the endless chain operatively engaged with a drive gear;
a direct current electric motor mounted longitudinally in the handle portion, a drive shaft of the motor terminating in a worm gear that transmits drive torque to the drive gear;
wherein the cutting bar and electric motor are sized and positioned within the housing such that a balance point of the housing is located at an end of the handle portion in the direction of the cutting bar.
